(19) United States
(12) Patent Application Publication
(10) Pub. No.: US 2014/0300549 A1
(43) Pub. Date: Oct. 9, 2014

(54) Computer Mouse

(71) Applicant: Dale McPhee Purcocks, Blackrock (IE)

(72) Inventor: Dale McPhee Purcocks, Blackrock (IE)

(21) Appl. No.: 14/206,309

(22) Filed: Mar. 12, 2014

Related U.S. Application Data
(63) Continuation of application No. 11/997,447, filed on Apr. 10, 2008, now abandoned.

(30) Foreign Application Priority Data
Aug. 1, 2005 (GB) 0515797.9

(51) Int. Cl. G06F 3/0354

(52) U.S. Cl. CPC G06F 3/03543
USPC 345/163

(57) ABSTRACT

A computer mouse, wherein the electronic circuitry associated with the mouse is physically isolated from the outside environment by means of a sealed housing and the use of a non-physical coupling between the operating means and the movement centre which detects movement of the operating means and enables such movement to be translated into an electrical signal representative of the movement.

The present invention relates generally to an input device for a computer and, more particularly, to a computer mouse.

A mouse is a well known human-computer interface for moving an onscreen cursor on a computer, enabling the user to navigate, activate and interact with software programs running on the computer.

It is highly desirable for computer peripherals, including computer mice, to be washable, or at least withstand the ingress of liquid. However, the electronic circuitry therein would suffer immediate, and possibly permanent, damage in the event of contact thereof with any significant quantity of liquid.

It is therefore an object of the present invention to provide an input device, in the form of a mouse, that is resistant to the ingress of liquid.

In accordance with the present invention there is provided an input device comprising a moveable operating means and a movement sensor for sensing movement of said operating means and generating an electric control signal representative thereof, said input device comprising a housing defining a liquid-tight enclosure, said device comprising support means on which is mounted said operating means in an accessible position relative to a user, wherein a liquid-tight barrier is provided between said operating means and said enclosure, the device further comprising non-physical coupling means for coupling said operating means to said movement sensor through said barrier.

Thus, the above mentioned object is achieved by providing an arrangement wherein the electronic circuitry associated with the mouse is physically isolated from the outside environment. This is achieved by means of a sealed housing, and use of a non-physical coupling between the operating means and the movement sensor which detects movement of the operating means and enables such movement to be translated into an electrical signal representative of said movement.

Preferably, said housing further defines at least one recess externally of said liquid-tight enclosure, wherein a liquid-tight barrier is provided between said at least one recess and said enclosure, wherein said operating means is provided within said at least one recess.

Preferably, said non-physical coupling means comprises means for generating a magnetic field by means of which movement of said operating means is translated to said movement sensor. In one exemplary embodiment, a first magnetic means is positioned on one side of the barrier in respect of said operating means and a second magnetic means is positioned on the other side of the barrier in respect of said movement sensor, such that a magnetic field is generated through said barrier between said first and second magnetic means.

Beneficially, at least one of said first and second magnetic means comprises a permanent magnet. In a preferred embodiment, one or each of said first and second magnetic means comprises at least two sectored, multi-pole magnets which are opposed to each other.

Preferably, said operating means comprises a roller, rotatably mounted on an axle which, in one exemplary embodiment, may be static in use. The roller and, optionally, the axle may be removably mounted in or on said input device.

The movement sensor may comprise a potentiometer.

The input device may comprise a computer mouse.

In a preferred embodiment, said housing comprises a cover and a base mounted together with sealing means, such as a gasket or the like, therebetween. In the case where the operating means is provided in a recess, the recess may be defined in the form of first and second channel portions, each extending inwardly from the cover and the base respectively of the housing, wherein said first and second channel portions are connected together, when the cover and base are mounted together, with a seal therebetween.

These and other aspects of the present invention will be apparent from, and elucidated with reference to, the embodiment described herein.

An embodiment of the present invention will now be described by way of example only and with reference to the accompanying drawings, in which:

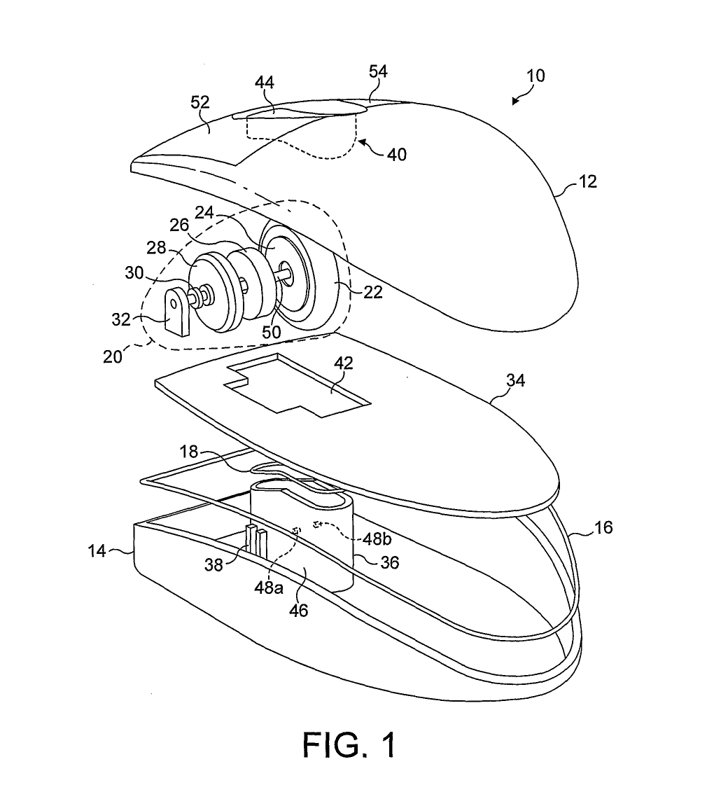

FIG. 1 is an exploded view of a mouse assembly according to an exemplary embodiment of the present invention;

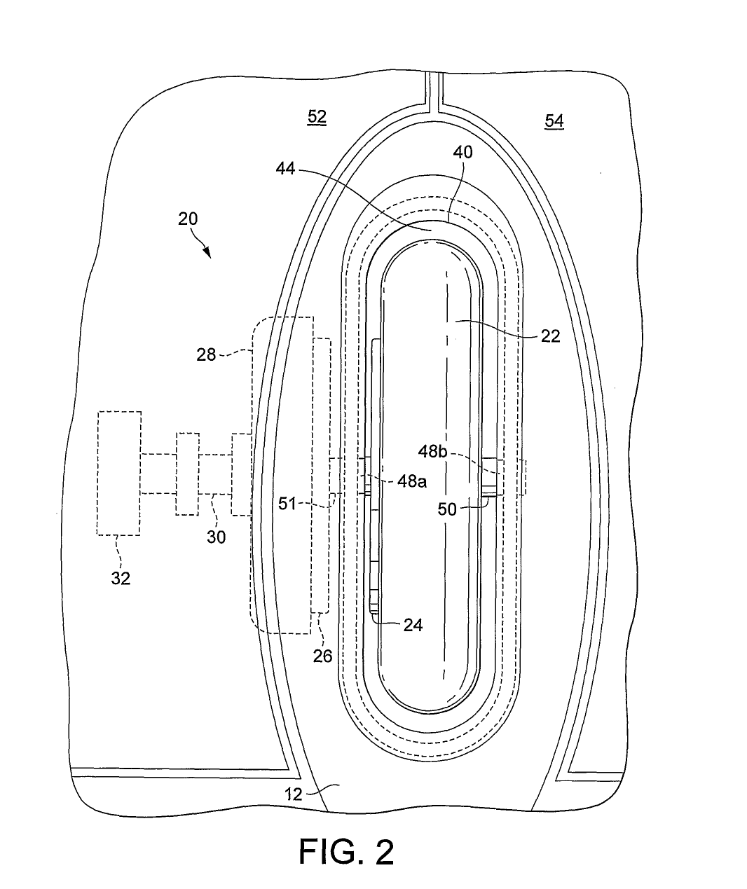

FIG. 2 is a plan view of the mouse assembly of FIG. 1, showing the scrolling wheel components; and

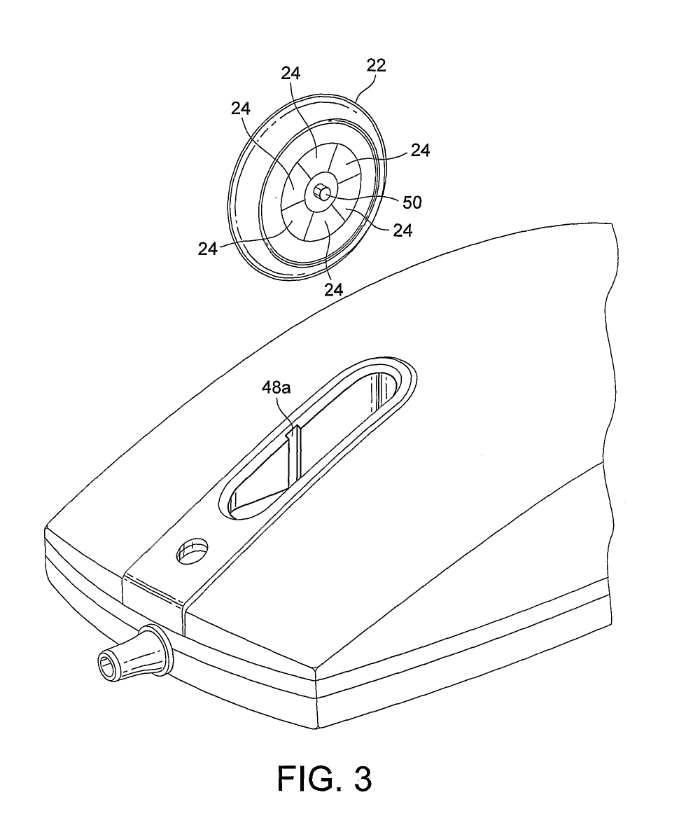

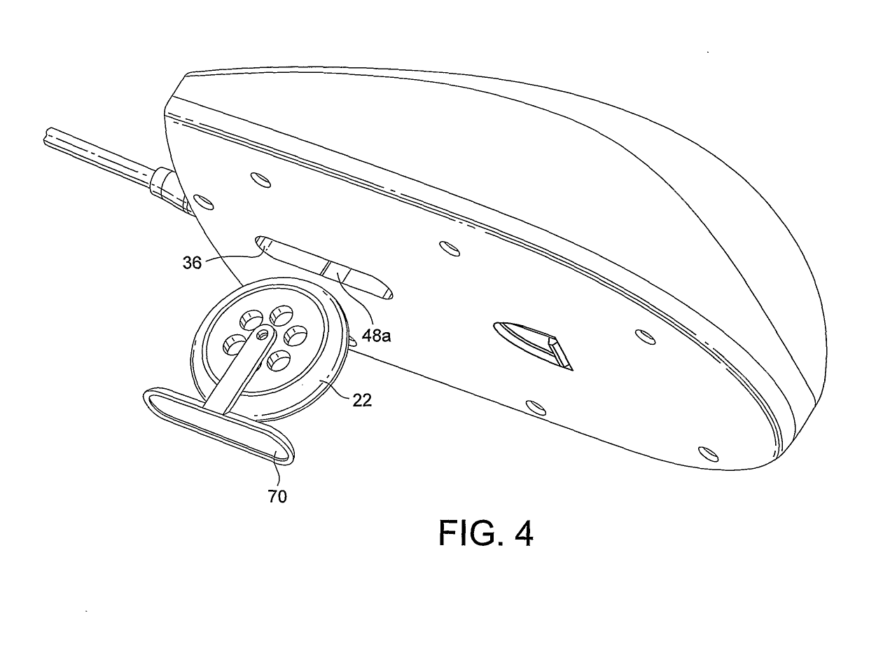

FIG. 3 and FIG. 4 are perspective views of the mouse in an alternative embodiment, indicating the removable scrolling wheel and axle.

Referring to FIG. 1 of the drawings, a mouse 10 according to an exemplary embodiment of the present invention comprises a housing defined by a rigid base 14 and corresponding cover 12, mounted together with a gasket 16 therebetween, the gasket 16 being formed of a liquid impermeable flexible material so as to provide a liquid-tight seal between the over 12 and the base 14. The outer profile of the cover 12 is ergonomically styled to be accepted comfortably by the palm of a hand. The cover 12 is provided with a longitudinal elongate slot 44 defining the access opening to a channel 40, of similar configuration to the slot 44 and extending downwardly into the enclosure defined by the housing. A similarly-configured channel 36 extends upwardly, from a slot (not shown) in the base 14, into the enclosure defined by the housing such that, when the mouse 10 is assembled, the distal ends of the two channels 36, 40 are joined together, with a liquid-tight seal 18 therebetween, so as to form a single channel that runs vertically through the enclosure defined by the housing, from the cover 12 to the base 14.

Two apertures or, more preferably slots 48a, 48b (see FIG. 3 of the drawings) are provided in opposing faces of the lower channel 36 so as to define a transverse path through the lower channel 36, across which is supported a roller assembly 20.

A printed circuit board (PCB) 34 is mounted within the housing, which PCB 34 carries the electronic circuitry associated with the mouse 10, and has an opening 42 therein of a shape and configuration to allow the distal end of the lower channel 36 and part of the roller assembly 20 to pass through when the mouse is in the assembled configuration. The PCB 34 can be mounted on the base 14 by any fixing means, such as adhesive, screws etc. and the present invention is not intended to be limited in this respect. It will be apparent, therefore, that liquid can now only enter the space between the cover 12 and the base 14 via the channel 40, 36. The left standard button 52 and the right standard button 54, situated towards the front of the cover 12, are both provided with a liquid-tight seal to ensure this is so.

Referring additionally to FIG. 2 of the drawings, the roller assembly 20 comprises a roller 22 rotatably mounted on a rigid axle 50 which is statically mounted between the apertures or slots 48a, 48b within the lower channel 36. In one embodiment, the apertures 48a, 48b may extend through the wall of the channel in which case, the axle 50 would be static such that the apertures 48a, 48b within which it is supported at each end can be sealed, and any liquid entering the channel 40, 36 is prevented from ingressing into the rest of the enclosure defined by the housing by the seals provided at the apertures 48a, 48b and the seal 18 between the upper and lower channels 40, 36. In an alternative, more preferred embodiment, as illustrated in FIG. 3, the axle 50 may be removably supported in longitudinal slots 48a, 48b, that do not extend through the channel wall, but are formed in the wall of the channel, so that the roller 22 and axle 50 can be removed for cleaning. The roller 22 may be mounted in the channel 40, 46 via an opening in the lower channel 36, wherein a cover 70 is provided to cover the opening once the roller 22 is in place. The roller assembly can be removed by dislodging the cover 70 from the opening and drawing the assembly out of the channel.

In a conventional computer mouse, the roller is generally provided on a rotary shaft which is connected to a potentiometer, wherein rotation of the roller and, therefore the shaft, causes a corresponding change in the restive value of the potentiometer which, in turn, is transformed into a signal applied to the computer to perform a desired action.

The mouse 10 according to this exemplary embodiment of the invention operates in a similar manner in that a potentiometer 32 is provided, wherein changes in the restive value of the potentiometer 32 effect the desired input actions. However, in this case, the axle 50 is static. Thus, instead, a permanent magnet 26 is rotatably mounted, via a stub axle 51, on the outside of the channel 36 facing the roller 22, and a disc shaped permanent magnet 24 is attached to the roller 22 on the side of the barrier, facing the magnet 26. The magnet 26 is fixed to a non-metallic cap 28, which is connected to a rotating shaft 30 coupled to a potentiometer 32. In an alternative embodiment, as illustrated in FIG. 3, one or both of the magnets may actually comprise an array, constructed of multiple segmented magnets of alternately opposing polarities. The purpose of this would be to ensure that torque, generated by turning the magnetic coupling, remains at or adjacent the outer circumference of the magnetic portion of the roller 22 as opposed to at the axis.

Thus, in use, the user rotates the roller 22 (through the slot 44 in the cover 12), which causes rotation of the magnet 24 attached thereto. Magnetic coupling between the magnet 24 and the magnet 26 outside the channel 36 causes corresponding rotation of the outer magnet 26 which, in turn, causes the shaft 30 to rotate relative to the potentiometer 32. Resultant changes in its resistive value effect operation in the conventional manner.

Thus, even if the mouse is submerged in liquid, ingression of any liquid into contact with the PCB is prevented because the housing is sealed on the outside by the gasket 16 at the join between the cover 12 and the base 14, and the channel 40, 36 is sealed on the inside by the gasket 18 at the join between the distal ends of the channel 40, 36 and the seal between the ends of the static axle 50 and the slots 48a, 48b supporting it. Liquid can flow right through the channel 36, 40 without entering the inner enclosure housing the sensitive electronic circuitry.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements. In a device claim enumerating several means, several of these means may be embodied by one and the same item of hardware. The mere fact that certain measures are recited in mutually different dependent claims does not indicate that a combination of these measures cannot be used to advantage.

1. An input device comprising a moveable operating means and a movement sensor for sensing movement of said operating means and generating an electric control signal representative thereof, said input device comprising a housing defining a liquid-tight enclosure, said device comprising support means on which is mounted said operating means in an accessible position relative to a user, wherein a liquid-tight barrier is provided between said operating means and said enclosure, the device further comprising non-physical coupling means for coupling said operating means to said movement sensor through said barrier

2. An input device according to claim 1, wherein said housing further defines at least one recess externally of said liquid-tight enclosure, wherein a liquid-tight barrier is provided between said at least one recess and said enclosure, and wherein said operating means is provided within said at least one recess.

3. An input device according to claim 1, wherein said operating means is removably mounted in or on said input device.

4. An input device according to claim 3, wherein said non-physical coupling means comprises means for generating a magnetic field by means of which movement of said operating means is translated to said movement sensor by way of a first magnetic means, positioned on one side of the barrier in respect of said operating means and a second magnetic means, positioned on the other side of the barrier in respect of said movement sensor, such that a magnetic field is generated through said barrier between said first and second magnetic means.

5. An input device according to claim 4, wherein at least one of said first and second magnetic means comprises a permanent magnet.

6. An input device according to claim 5, wherein one or each of said magnetic means comprises at least two sectored, multi-pole magnets which are opposed to each other.

7. An input device according to claim 1, wherein said operating means comprises a roller, rotatably mounted on an axle.

8. An input device according to claim 1, wherein said movement sensor comprises a potentiometer.

9. An input device according to claim 1, wherein said input device comprises a computer mouse.

10. An input device according to claim 1, wherein said housing comprises a cover and a base mounted together with liquid-tight sealing means therebetween.

11. An input device according to claim 2, wherein said housing comprising a cover and a base mounted together with a sealing means therebetween, wherein said recess is defined in the form of first and second opposing channel portions, each extending inwardly from the cover and the base respectively of the housing, wherein said first and second channel portions are connected together, when the cover and base are mounted together with a liquid-tight seal therebetween.

12. An input device according to claim 1, further comprising one or more additional operating means for generating an electric control signal representative of operation thereof, said one or more additional operating means defining a liquid-tight boundary between a user contact surface and said liquid-tight enclosure defined by said housing.

13. (canceled)
